(19) United States
(12) Patent Application Publication
(10) Pub. No.: US 2010/0226379 A1
(43) Pub. Date: Sep. 9, 2010

(54) Policy control method and system for layer two devices

(75) Inventors: Mo Sun, Shenzhen (CN); Xiaofeng Shi, Shenzhen (CN)

Correspondence Address: Oppedahl Patent Law Firm, LLC- China Pat, P O Box 5940, Dillon, CO, 80435-5940, US

(73) Assignee: ZTE CORPORATION, Shenzhen, Guangdong (CN)

(21) Appl. No.: 12/674,678

(22) PCT Filed: Jul. 8, 2008
(86) PCT No.: PCT/CN2008/071582

§ 371 Date: Feb. 23, 2010

(30) Foreign Application Priority Data
Oct. 30, 2007 (CN) 200710163760.4

(51) Int. Cl. H04L 12/56

(52) U.S. Cl. 370/400

(57) ABSTRACT

A policy control method for layer two devices is disclosed. Said method includes: after the Resource and Admission Control Subsystem (RACS) generates the policy of layer two device, said policy of layer two device is sent down to the IP border point; said IP border point notifies said policy of layer two device to layer two device. A policy control system for layer two devices is disclosed. Said system comprises RACS, layer two devices and IP border point. After generating the policy of layer two devices, said RACS is used to send said policy of layer two device down to IP border point. The IP border point is used to notify the policy of layer two device to layer two device. The layer two device is used to receive and perform the policy of layer two device. By employing said method and system, the policy control for layer two device is easy to be operated and realized, the maintenance is simple, and the cost of maintenance is reduced.

### TECHNICAL FIELD

The present invention relates to the field of communications, especially to a policy control method and system for layer two devices.

### BACKGROUND

Next Generation Network (NGN) brings a protruding problem in Quality of Service (QoS) aspect due to the adoption of packet-switched technique, especially Internet Protocol (IP) technique in the carrier network.

Resource and Admission Control Subsystem (RACS) is a subsystem proposed by European Telecommunications Standards Institute (ETSI) to solve the QoS problem of NGN carrier network.

In the latest RACS draft publicized in June 2007 by ETSI Telecommunications and Internet converged services and protocols for advanced networking (TISPAN), functional architecture of RACS is provided, as shown in FIG. 1, wherein:

Service-based Policy Decision Function (SPDF) requests to select local policy according to resource request from Application Function (AF), and maps the request to IP QoS parameters, then sends the parameters to generic Resource and Admission Control Function (x-RACF) and Border Gateway Function (BGF) to request for corresponding resource.

x-RACF receives the request from SPDF, and performs admission control based on the stored policy, accepting or rejecting the request of transmitting resource. X-RACF can obtain network attachment information and user QoS subscription information from Network Attachment Sub-System (NASS) via e4 reference point, so that available network resources can be determined according to network location information (e.g., physical node address of an accessed user), and the user QoS subscription information can be referred to when resource distribution request is being processed.

BGF is located between the access network and the core network (implementing core border gateway function), or BGF can be a gateway between two core networks. BGF accomplishes functions of Network Address Translation (NAT), gating, QoS label, bandwidth limitation, utilization measurement and resource synchronization under the control of SPDF.

Resource Control Enforcement Function (RCEF) is located at IP border point of access network or access network layer two devices (e.g., Digital Subscriber Line Access Multiplexer (DSLAM), Ethernet switch), performing the policy transmitted by x-RACF via Re reference point, and accomplishing functions of gating, QoS label, bandwidth limitation and so on.

Basic Transmission Function (BTF) is a function entity located in transport layer for processing multicast replication, routing and so on.

In order to guarantee QoS of a user service flow in the access network, after making policy decision according to resource request of the service flow, RACS must send the policy down to all network elements that the service flow passes through in the access network, including the gateway, IP border point and layer two devices in convergence level. As shown in FIG. 2, it is a diagram illustrating policy control in a Digital Subscriber Line (DSL) access network.

As to a layer three device such as IP border point (e.g., Broadband Remote Access Server (BRAS)), RACS directly sends down and enforces the content of a layer three control policy via a Re interface through RACF; as to a gateway router, it is SPDF that sends down and enforces the layer three device policy via an Ia interface.

As to layer two devices of convergence level (e.g., Ethernet switch and DSLAM), the existing technique is to predefine some layer two device policies in these devices, and RACS sends down the layer two device policy ID via Re interface to activate or deactivate the policy for enforcement.

The existing policy control process of a layer two device is shown in FIG. 3:

step 301, firstly, configuring some possible predefined policies for the layer two device;

step 302, when making a policy decision, RACS has to know which predefined policies are available, so the predefined policies of this layer two device should be synchronous with RACS, and the synchronization can be implemented through messages or synchronization configuration;

step 303, User Equipment (UE) initiates a service request to AF;

step 304, AF initiates a resource request to RACS according to the required resource of service;

step 305, RACS and NASS exchange subscription information of the user;

step 306, RACS makes the final admission decision according to subscription information and current resource status, and selects a proper layer two predefined policy, and generates a layer three control policy;

step 307, RACS sends ID of the layer two device policy down to the layer two device;

(note: the process of sending layer three device policy down to IP border point and BGF is omitted here;)

step 308, the layer two device activates corresponding predefined policy according to the layer two device policy ID sent down;

step 309, the layer two device returns a sending down policy response to RACS;

step 310, RACS returns a resource request response to AF;

step 311, AF returns a service request response to UE.

There are several problems in the existing policy control technique of layer two devices as follows:

(1) with so many layer two convergence level devices and more and more types of services provided by the service provider, differentiation service is becoming more and more intensive, and the number of predefined policies will also be increasing, so it is rather difficult for service providers to configure a number of predefined policies for numerous devices, and the maintenance cost will also be very high;

(2) there is not a specific scheme in the protocol yet for the RACS as how to send a layer two device policy to a layer two device. Since there are many layer two convergence level devices, it is impossible for RACS to connect directly with all the devices for policy control, so a method for distributing a layer two device policy to the corresponding layer two device is required.

### SUMMARY

The technical problem the present invention aims to solve is to provide a policy control method and system for layer two devices, so as to solve the problem in existing technique that it is difficult to use predefined policies, and that RACS can not directly send a layer two device policy down to the corresponding layer two device.

To solve the above problem, the present invention provides a policy control method of layer two devices, comprising:

after generating a layer two device policy, Resource and Admission Control Subsystem (RACS) sends the layer two device policy down to IP border point, and the IP border point notifies the layer two device of the layer two device policy.

Further, the method further comprises the following steps:

(1) after generating the layer two device policy dynamically, RACS sends the layer two device policy down to the IP border point;

(2) policy distributing function of the IP border point notifies the layer two device of the layer two device policy;

(3) the layer two device receives and enforces the layer two device policy.

Further, the method may comprise:

the layer two device policy comprises: policy ID, policy type, user ID, flow description, Quality of Service (QoS) information and gating information.

Further, the method may comprise:

the IP border point is a Broadband Remote Access Server (BRAS), and the layer two device is an Ethernet switch.

Further, the method may comprise:

in the step (1), RACS generates the layer two device policy dynamically according to resource request, user subscription information and resource availability status obtained from transport layer function.

Further, the method may comprise:

in the step (1), RACS sends the layer two device policy down to the IP border point by generic Resource and Admission Control Function (x-RACF) via Re interface.

Further, the method may comprise:

in the step (1), RACS generates a layer three device policy dynamically according to resource request, user subscription information and resource availability status obtained from transport layer function.

Further, the method may comprise:

in the step (1), the RACS sends the layer two device policy and the layer three device policy, which are organized in one message or in different messages respectively, down to the IP border point;

Further, the method may comprise:

in the step (2), after the IP border point has received the layer two device policy, according to information in the policy and networking status of the layer two network connected to IP border point, the policy distributing function sends the layer two device policy down to corresponding layer two device via Re′ interface by taking use of layer two control mechanism, and the layer two control mechanism is an access node control protocol.

Further, the method may comprise:

in the step (3), the Resource Control Enforcement Function (RCEF) of the layer two device enforces the layer two device policy.

To solve the above problem, the present invention also provides a policy control system for layer two devices, comprising:

a Resource and Admission Control Subsystem (RACS), layer two devices and a IP border point;

the RACS is used for sending the layer two device policy down to the IP border point after generating the layer two device policy;

the IP border point is used for notifying the layer two device of the layer two device policy;

the layer two device is used for receiving and enforcing the layer two device policy.

Further, the system may comprise:

the IP border point comprises a policy distributing function, which is used for notifying the layer two device of the layer two device policy.

Further, the system may comprise:

the layer two device policy comprises: policy ID, policy type, user ID, flow description, Quality of Service (QoS) information and gating information.

Further, the system may comprise:

the IP border point is a Broadband Remote Access Server (BRAS), and the layer two device is an Ethernet switch.

Further, the system may comprise:

the RACS generates the layer two device policy dynamically according to resource request, user subscription information and resource availability status obtained from the transport layer function.

Further, the system may comprise:

RACS is used for sending the layer two device policy down to the IP border point by generic Resource and Admission Control Function (x-RACF) via Re interface.

Further, the system may comprise:

RACS is also used for generating a layer three device policy dynamically according to resource request, user subscription information and resource availability status obtained from the transport layer function;

RACS is also used for sending the layer two device policy and layer three device policy, which are organized in one message or in different messages respectively, down to the IP border point.

Further, the system may comprise:

after the IP border point has received the layer two device policy, according to information in the policy and networking status of the layer two network connected to IP border point, the policy distributing function sends the layer two device policy down to corresponding layer two device via Re′ interface by taking use of layer two control mechanism, and the layer two control mechanism is an access node control protocol.

Further, the system may comprise:

the layer two device comprises a Resource Control Enforcement Function (RCEF), which is used for enforcing the layer two device policy.

The present invention provides a policy control method and system for a layer two device. In this method and system, a layer two device policy is generated by RACS and sent down to IP border point, and then the IP border point notifies the layer two device of the layer two policy; by adopting this method and system, policy control for the layer two device is easy to be operated and realized, the maintenance is more simple, and the cost of maintenance is reduced.

### BRIEF DESCRIPTION OF THE DRAWINGS

FIG. 1 is a diagram illustrating the structure of Resource and Admission Control Subsystem (RACS) of ETSI in existing technology;

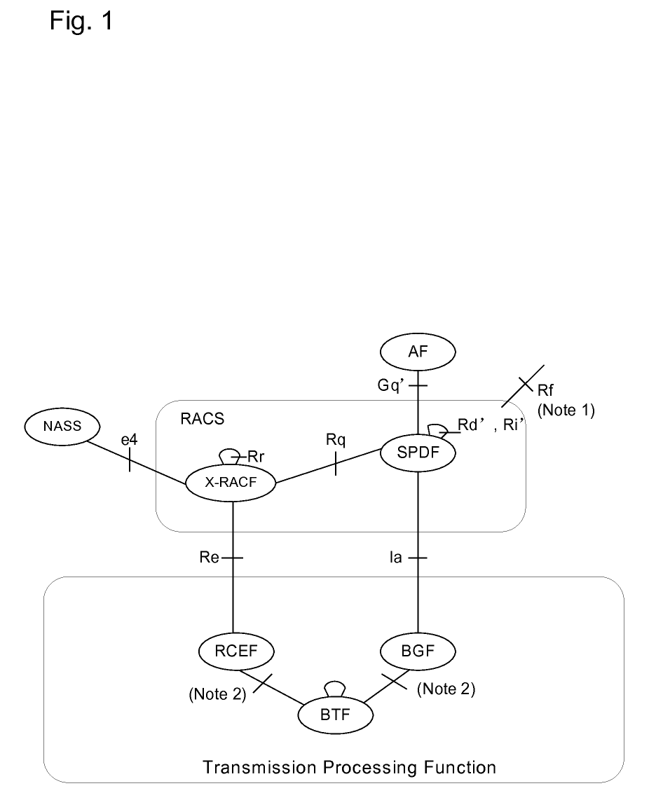

FIG. 2 is a diagram illustrating the networking for policy control in a DSL access network in existing technology;

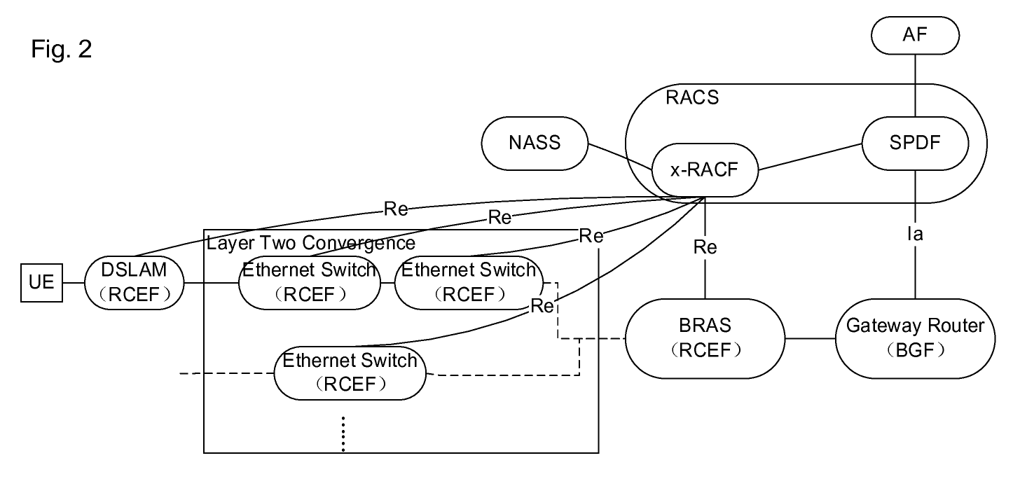

FIG. 3 is a flowchart illustrating the interacting process of policy control for a layer two device in existing technology;

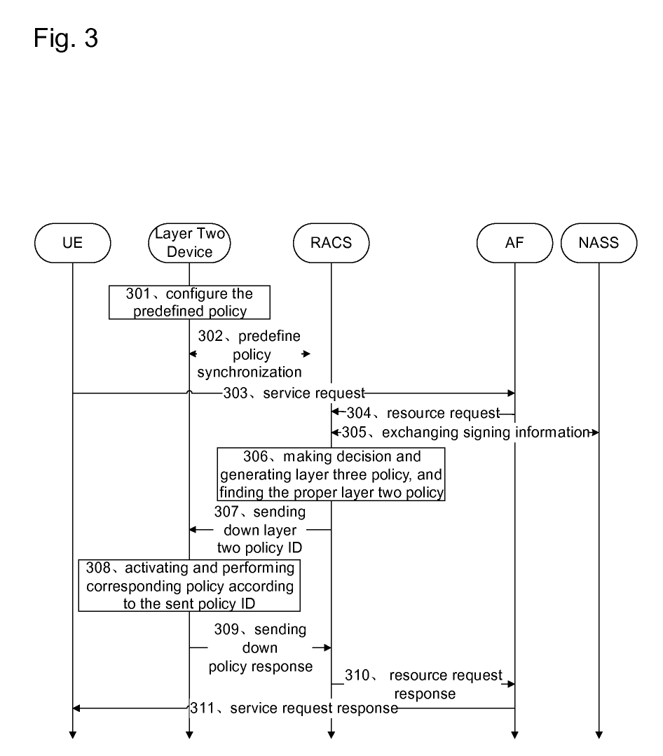

FIG. 4 is a diagram illustrating the networking for policy control in a DSL access network in the embodiment of the present invention; and

FIG. 5 is a flowchart illustrating the interacting process of policy control for a layer two device in the embodiment of the present invention.

### DETAILED DESCRIPTION

Technical scheme of the present invention will be illustrated in further details hereinafter with reference to the drawings and embodiments.

The core idea of the present invention is that: after generating a layer two device policy, RACS sends the generated layer two device policy down to IP border point, and the IP border point notifies the layer two device of the layer two device policy.

The present invention will be illustrated in detail hereinafter with reference to the drawings and specific embodiments.

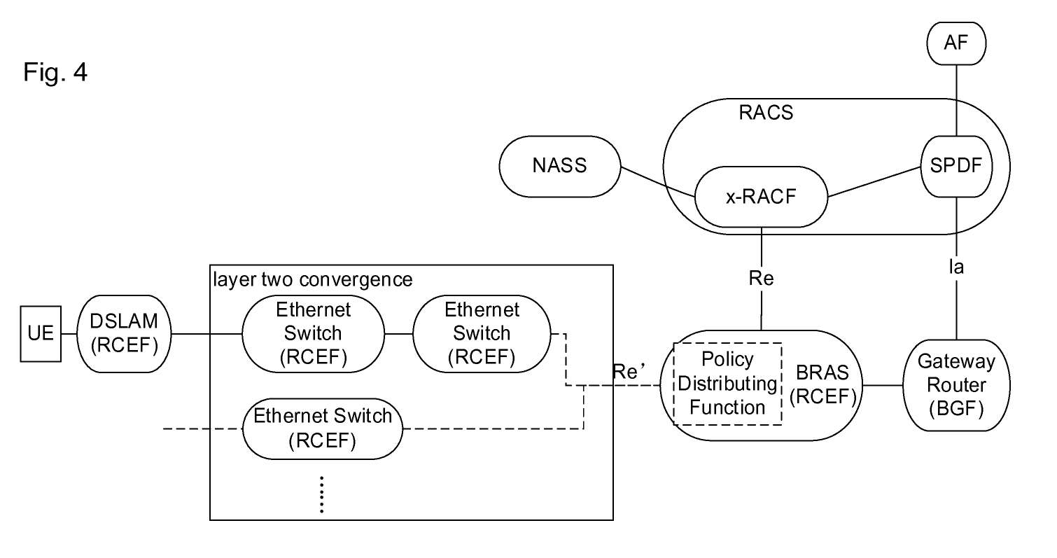

As shown in FIG. 4, taking the most common DSL access network for example, as to a layer two device (e.g., DSLAM, convergence switch), it is RACS that generates the layer two device policy dynamically according to resource request, user subscription information and resource availability status obtained from transport layer function, and then x-RACF sends the policy down to IP border point (which is BRAS in this example) via Re interface, and the policy distributing function of IP border point distributes the policy via Re′ interface by taking use of layer two control mechanism, and the RCEF function of the layer two device enforces the policy.

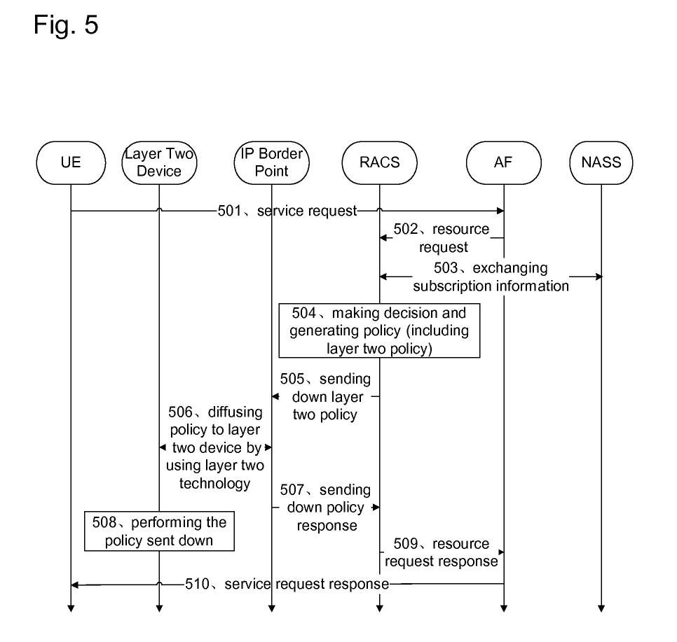

As shown in FIG. 5, the method of policy control for a layer two device comprises the following steps:

step 501, UE initiates a service request to AF;

step 502, AF initiates a resource request to RACS according to the required resource of service;

step 503, RACS and NASS exchange subscription information of the user;

step 504, RACS makes the final admission decision according to the received resource request, the user subscription information and current resource availability status obtained from transport layer function, and respectively generates a layer two device policy and a layer three device policy, wherein content of the layer two device policy may comprise: policy ID (used for identifying the policy uniquely), policy type (identifying it as a layer two device policy or a layer three device policy), user ID (used for uniquely determining the user, such as IP address, MAC address and so on), flow description (information for describing the flow, which can be an IP quinary set, or layer two information like Virtual Local Area Network Tag (VLAN TAG) etc), QoS information (bandwidth, QoS level and so on) and other information (gating etc);

step 505, as to a layer three device policy, which is sent down to IP border point by x-RACF via Re interface and to BGF by SPDF via Ia interface; as to a layer two device policy, it is also sent to IP border point by x-RACF via Re interface;

when a layer two device policy is sent down to IP border point, this layer two device policy and the layer three device policy can be sent down by organizing in one message, or be sent down in different messages respectively;

step 506, after receiving the policy, if IP border point determines that this policy is a layer two device policy according to the policy type, according to the policy content and networking status of the connected layer two network, the policy distributing function of IP border point will distribute the layer two policy to corresponding layer two device (namely the layer two device that service flow will pass through) via Re′ interface by taking use of layer two control mechanism, such as Access Node Control Protocol (ANCP), or as to an Ethernet network, extend an Ethernet-based sub protocol, for instance: a kind of sub protocol type is extended based on Ethernet protocol multicast message, the format of which is: protocol type, message length, message content (some Attribute Value Pair (AVP) describing the policy);

step 507, after finishing distributing the layer two device policy, IP border point may return a sending down policy response message to RACS;

IP border point may return the response to RACS after confirming that all corresponding layer two devices related to the layer two device policy have received the policy and have responded, or may also return the response to RACS after the layer two device policy is distributed out;

step 508, after receiving the layer two device policy, according to the content of the policy, the layer two device identifies related user service flow, which is controlled by policy control of QoS related control or gating etc;

step 509, RACS returns a resource request response to AF;

step 510, AF returns a service request response to the user.

The above embodiment takes the current most common DSL access network for example to illustrate the present invention, and other types of access network have similar process, which are not to be illustrated hereby.

The present invention also provides a policy control system for layer two device, comprising a Resource and Admission Control Subsystem (RACS), a layer two device and IP border point;

RACS is used for sending the layer two device policy down to IP border point after generating the layer two device policy, and the layer two device policy comprises: policy ID, policy type, user ID, flow description, Quality of Service (QoS) information and gating information; the IP border point is used for notifying the layer two device of the layer two device policy; the layer two device is used for receiving and enforcing the layer two device policy, and may comprise Resource Control Enforcement Function (RCEF), which can be used for enforcing the layer two device policy, and the layer two device can be an Ethernet switch.

Wherein, the IP border point is a Broadband Remote Access Server (BRAS), which comprises policy distributing function, and this policy distributing function can be used for notifying the layer two device of the layer two device policy.

The above-mentioned RACS is used for generating a layer two device policy dynamically according to resource request, user subscription information and resource availability status obtained from transport layer function, and sending this layer two device policy down to the IP border point by generic Resource and Admission Control Function (x-RACF) via Re interface.

The above-mentioned RACS is also used for generating a layer three device policy dynamically according to resource request, user subscription information and resource availability status obtained from transport layer function, and this layer two device policy and the layer three device policy can be sent down to IP border point by organizing in one message, or in different messages respectively;

After receiving the layer two device policy, according to information in the policy and networking status of the layer two network connected to this IP border point, the IP border point distributes the layer two device policy to corresponding layer two devices by the policy distributing function via Re′ interface by taking use of the layer two control mechanism, which is the access node control protocol.

To sum up, by adopting method and system of the present invention, policy control for a layer two device in an access network can be implemented.

### INDUSTRIAL APPLICABILITY

The present invention provides a policy control method and system for a layer two device. In this method and system, a layer two device policy is generated by RACS and is sent down to IP border point, and then the IP border point notifies the layer two device of the layer two policy; by adopting the method and system, policy control for the layer two device is easy to be operated and realized, the maintenance is more simple, and the cost of maintenance is reduced.

What is claimed is:

1. A policy control method for layer two devices, comprising:
after generating a layer two device policy, Resource and Admission Control Subsystem (RACS) sending the layer two device policy down to IP border point, and the IP border point notifying the layer two device of the layer two device policy.

2. The method according to claim 1, comprising the following steps:
(1) after generating the layer two device policy dynamically, RACS sending the layer two device policy down to the IP border point;
(2) policy distributing function of the IP border point notifying the layer two device of the layer two device policy;
(3) the layer two device receiving and enforcing the layer two device policy.

3. The method according to claim 1, wherein,
the layer two device policy comprises: policy ID, policy type, user ID, flow description, Quality of Service (QoS) information and gating information.

4. The method according to claim 1, wherein,
the IP border point is a Broadband Remote Access Server (BRAS), and the layer two device is an Ethernet switch.

5. The method according to claim 2, wherein,
in the step (1), RACS generates the layer two device policy dynamically according to resource request, user subscription information and resource availability status obtained from transport layer function.

6. The method according to claim 2, wherein,
in the step (1), RACS sends the layer two device policy down to the IP border point by generic Resource and Admission Control Function (x-RACF) via Re interface.

7. The method according to claim 2, wherein,
in the step (1), RACS generates a layer three device policy dynamically according to resource request, user subscription information and resource availability status obtained from transport layer function;
in the step (1), RACS sends the layer two device policy and layer three device policy, which are organized in one message or in different messages respectively, down to the IP border point.

8. The method according to claim 2, wherein,
in the step (2), after the IP border point has received the layer two device policy, according to information in the policy and networking status of the layer two network connected to IP border point, the policy distributing function sends the layer two device policy down to corresponding layer two devices via Re′ interface by taking use of layer two control mechanism, and the layer two control mechanism is an access point control protocol.

9. The method according to claim 2, wherein,
in the step (3), the Resource Control Enforcement Function (RCEF) of the layer two device enforces the layer two device policy.

10. A policy control system for layer two devices, comprising a Resource and Admission Control Subsystem (RACS) and layer two devices, and further comprising IP border point;
the RACS being used for sending the layer two device policy down to the IP border point after generating the layer two device policy;
the IP border point being used for notifying the layer two device of the layer two device policy;
the layer two device being used for receiving and enforcing the layer two device policy.

11. The system according to claim 10, wherein,
the IP border point comprises a policy distributing function, and the policy distributing function is used for notifying the layer two device of the layer two device policy.

12. The system according to claim 10, wherein,
the layer two device policy comprises: policy ID, policy type, user ID, flow description, Quality of Service (QoS) information and gating information.

13. The system according to claim 10, wherein,
the IP border point is a Broadband Remote Access Server (BRAS), and the layer two device is an Ethernet switch.

14. The system according to claim 10, wherein,
the RACS generates the layer two device policy dynamically according to resource request, user subscription information and resource availability status obtained from transport layer function.

15. The system according to claim 10, wherein,
RACS is used for sending the layer two device policy down to the IP border point by generic Resource and Admission Control Function (x-RACF) via Re interface.

16. The system according to claim 10, wherein,
RACS is also used for generating a layer three device policy dynamically according to resource request, user subscription information and resource availability status obtained from transport layer function;
RACS is also used for sending the layer two device policy and layer three device policy, which are organized in one message or in different messages respectively, down to the IP border point.

17. The system according to claim 11, wherein,
after the IP border point has received the layer two device policy, according to information in the policy and networking status of the layer two network connected to IP border point, the policy distributing function sends the layer two device policy down to corresponding layer two device via Re′ interface by taking use of layer two control mechanism, and the layer two control mechanism is an access node control protocol.

18. The system according to claim 10, wherein,
the layer two device comprises a Resource Control Enforcement Function (RCEF), and the RCEF is used for enforcing the layer two device policy.

19. The method according to claim 2, wherein,
the layer two device policy comprises: policy ID, policy type, user ID, flow description, Quality of Service (QoS) information and gating information.

20. The method according to claim 2, wherein,
the IP border point is a Broadband Remote Access Server (BRAS), and the layer two device is an Ethernet switch.

21. The system according to claim 11, wherein,
the layer two device policy comprises: policy ID, policy type, user ID, flow description, Quality of Service (QoS) information and gating information.

22. The system according to claim 11, wherein,
the IP border point is a Broadband Remote Access Server (BRAS), and the layer two device is an Ethernet switch.
